(19) United States
(12) Patent Application Publication
(10) Pub. No.: US 2015/0120571 A1
(43) Pub. Date: Apr. 30, 2015

(54) Method for Carrying Out Smart Transactions

(71) Applicant: Enrique Ocejo Sanchez, Coronado, CA (US)

(72) Inventor: Enrique Ocejo Sanchez, Coronado, CA (US)

(21) Appl. No.: 14/061,928

(22) Filed: Oct. 24, 2013

(51) Int. Cl. G06Q 20/40

(52) U.S. Cl. CPC G06Q 20/4012
USPC 705/72

(57) ABSTRACT

The present invention describes a method for carrying out smart transactions involving the use of a variable PIN. In this process the variable PIN is a set of numbers and letters that are modified through every transaction based on specific information of the person that is making the transaction. As the person prepares to make a transaction over the internet, at a bank teller, at a store, with a check or any other type of monetary transaction, the user or this invention will calculate their variable PIN by using certain information known only by the account owner such as home address, company address, home phone number, social security number, other types of personal information & transaction information like the check number, the time, amount to be paid, date of issue, expiration of the credit card or even use mathematical constants such as Pi (3.1416). All of this information will be assembled together to create a certain formula which produces a variable PIN that only the costumer and verification entity will know. As a result of the before mentioned concepts, the objective of our invention is to create a smart variable PIN that is continuously modified with each transaction that is executed giving the customer added security when making a transaction.

### FIELD OF THE INVENTION

The present invention refers in general to the field of secure banking, and more particularly, to the area of securing transactions, such as checks, internet transactions, ATM machines, and the like.

### DESCRIPTION OF RELATED ART

Throughout history, banks, financial institutions, and most individuals who have completed a financial transaction, have been subject to theft, fraud or some other kind of monetary loss. At this present time there is much concern about the security of transactions of many types due to improvements in technology. Most individuals are hesitant to use credit cards due to the risk of other's using the information without their consent. In addition, more and more companies have had their checks cloned, which result in great losses for the company that has to deal without that money (liquidity) until the bank accepts it has been defrauded and compensates the company for their lack of secure procedures. While the internet is useful for searching information and products, many individuals hesitate before using their credit card and personal identification number (PIN) on the internet for buying a product, service or coupon, since the risk that this secret information may be lost or hacked as it is being processed by the retailer or other transaction partner.

### BRIEF SUMMARY OF THE INVENTION

An object of the present invention is to provide a method to allow people to make transactions with the certainty that they will not be subject to a fraud.

Another object of the present invention is to prevent transactions not accepted by the account owner.

A related object of the present invention is to generate a variable PIN number, increasing the difficulty for someone to use the financial information without the owner's consent.

In accordance with a preferred embodiment of the present invention, a method for preventing transactions done without the consent of the account owner comprises the steps of creating a variable personal identification number (VPIN) unique to the transaction by account owner, submitting said VPIN to a clearing institution for verification, creating a verification or decline authorization by the clearing institution, and allowing or declining said transaction. Such VPIN may be generated by information pertaining to the transaction and personal information known to the account owner.

Other objects and advantages will become apparent from the following descriptions, taken in connection with the accompanying drawings, wherein, by way of illustration and example, embodiments of the present invention are disclosed.

### BRIEF DESCRIPTION OF THE FIGURES

The novel features believed to be characteristic of the invention are set forth in the appended claims and claims yet to be filed. However, the invention itself, as well as a preferred mode of use and limber objectives and advantages thereof, will best be understood by reference to the following detailed description when read in conjunction with the accompanying Figures wherein:

FIG. 1 is a flow cart of a preferred embodiment of the present invention, showing the steps of the method when a user intends to write a check for a transaction.

FIG. 2 is flow chart of a preferred embodiment of the present invention, showing the steps of the method When a user intends to use the Internet or a credit card for a transaction.

### DETAILED DESCRIPTION OF THE PREFERRED EMBODIMENTS

Detailed descriptions of the preferred embodiments are provided herein. It is to be understood, however, that the present invention may be embodied in various forms. Various aspects of the invention may be inverted, or changed in reference to specific part shape and detail, part location, or part composition. Therefore, specific details disclosed herein are not to be interpreted as limiting, but rather as a basis for the claims and as a representative basis for teaching one skilled in the art to employ the present invention in virtually any appropriately detailed system, structure or manner.

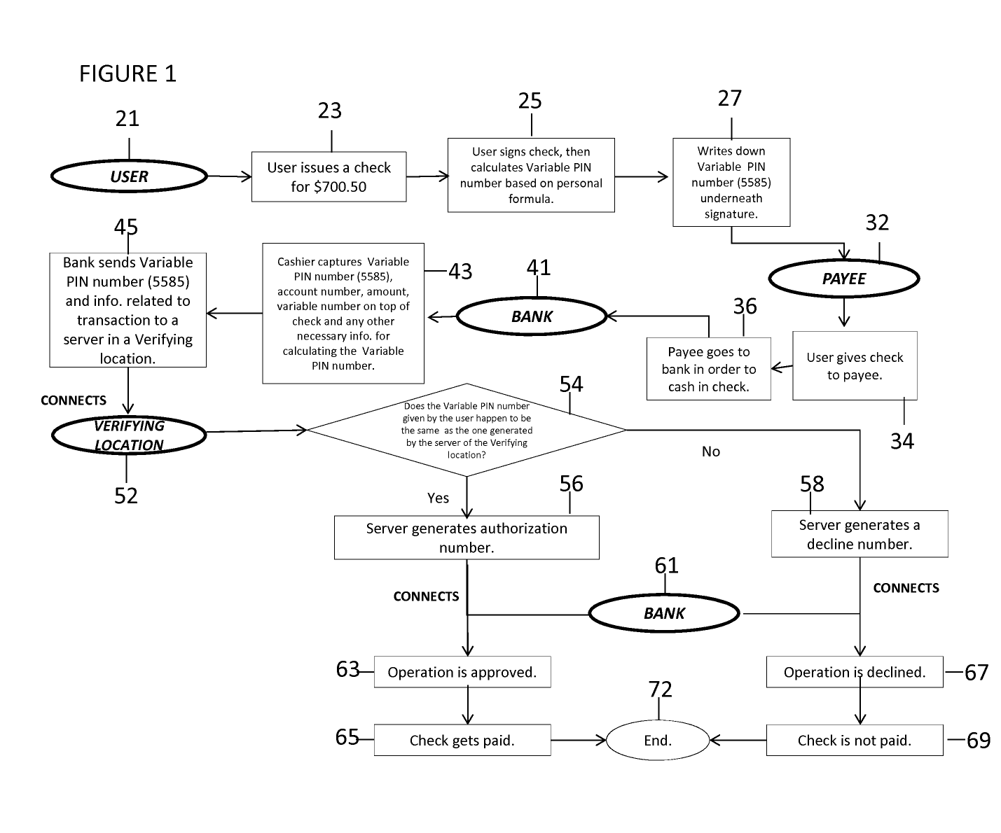

Turning first to FIG. 1, there is shown a preferred method of the invention for a user intending to use a check for a transaction. At steps 21, 23, a user issues a check for $700.50, for example, though any amount may be used. At step 25, the user signs the check and calculates a variable, personal information number, or variable PIN, described in more detail below. The user then writes the variable PIN somewhere on the check, such as beneath the signature, as in the illustrated example, at step 27. This variable PIN can be determined by and/or with input from the user.

At steps 12, 34, 36, the writer of the check gives the check to the payee and the payee presents the check to the bank. Next at steps 41, 43, 45, the bank captures the variable PIN, and other identifying information such as the account number, the amount, etc., and transmits this information to a location that can verify the information, including the variable PIN. At steps 52, 54, the variable PIN is calculated and compared against the variable PIN calculated by the user. If the variable PIN is the same, an authorization code or number is generated and delivered to the bank (step 61), wherein the operation is approved and the check is paid (steps 63, 65). In the event the variable PIN calculated does not match the variable PIN presented, a decline number is generated (step 58) and delivered to the bank (step 61), and the operation is declined and the check is not paid (steps 67, 69).

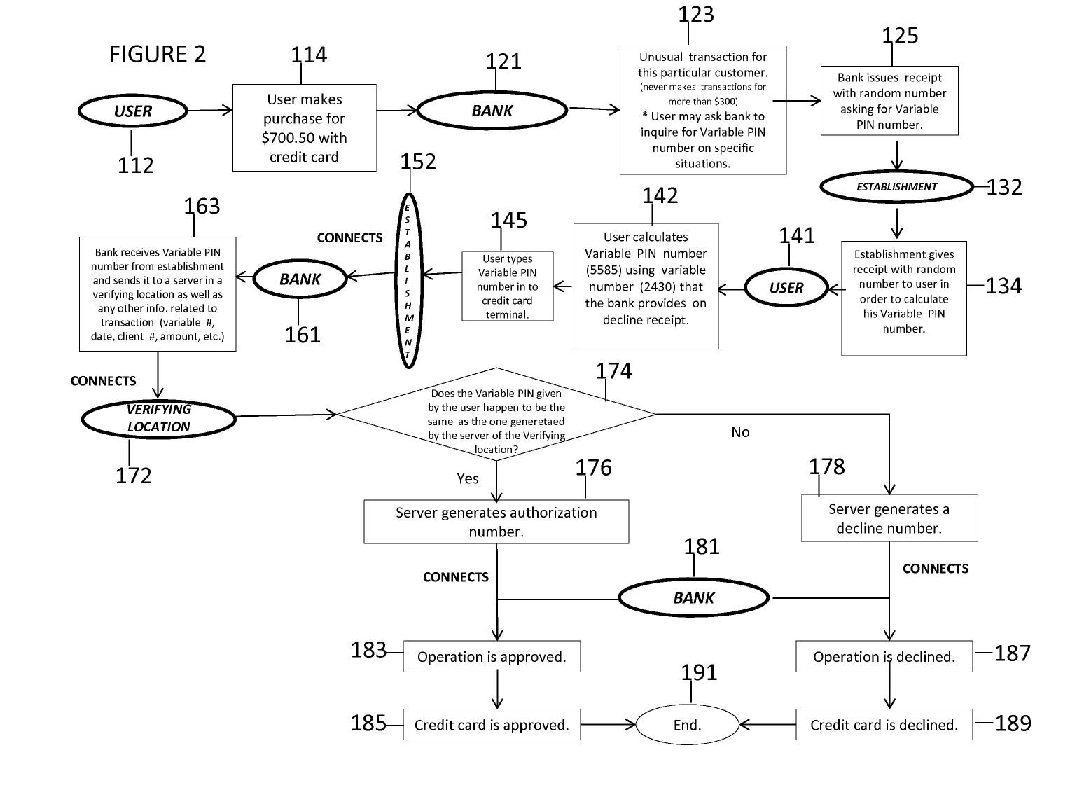

Turning next to FIG. 2, there is shown a preferred embodiment of the method wherein a user intends to use the Internet or a credit card for a transaction. At steps 112, 114, the user makes a purchase for $700.50, as an example, and presents a credit card, which is then transmitted to a bank or credit card processor at step 121. At this point, the transaction clearing entity may check if this is a usual transaction based on the user's purchasing history, and may ask for a variable PIN for any specific transaction (step 123). The processing entity, if requesting a variable PIN, may then issue a variable number at step 125 with which the user may calculate a variable PIN for the transaction, which in turn would present that variable number to the user, as in steps 132, 134, 141. As a result, the user would then calculate a variable PIN for the transaction (step 143), and input that variable PIN using a credit card terminal or otherwise present that information to the establishment (step 152).

The establishment then connects to the processing entity which then transmits information to a location that can verify the information, including the variable PIN calculated for the transaction, as illustrated at steps 152, 161, 163 and 172 in the preferred embodiment shown in FIG. 2. The remaining steps, steps 174, 176, 178, as well as steps 181, 183, 185, 187, 189 and 191 are similar to those steps described, in connection with a user presenting a check.

There exist several, almost unlimited, ways of generating a variable PIN for each transaction. A few examples of different types are described herein.

Example A, for credit card transactions and the like: Random number (four digits) issued by processing entity with a receipt multiplied by 0.20 (selected by the user's choice of their day of birth with 2 decimals) divided by 19.91 (selected by the user's choice of their year of birth with 2 decimals) and adding 155.4 (selected by the user's choice of their address number with 1 decimal)=RESULT (selecting two digits to the left and two digits to the right of the decimal point)=variable PIN (four digits).

1st Transaction: 8924 (a number issued by the processing entity)*0.20/19.91+155.4=245.043395. The variable PIN for this transaction is 4504, using two digits to the left of the decimal point (45) and two digits to the right (04).

2nd Transaction: 9354*0.20/19.91+155.4=249362833. The variable PIN for this transaction is (4936), using two digits to the left of the decimal point (49) and two digits to the right (36).

Example B (for credit card transactions and the like): Random number four digits) issued by processing entity with a receipt adding 331.09 (selected by the user's choice of their zip code with 2 decimals) multiplied by 3.1416 (selected by the user's choice of Pi with 4 decimals) and divided by 1.981 (selected by the user's choice of their marriage day with 3 decimals)=RESULT (Take two digits to the left and two digits to the right)=variable PIN (four digits).

1st Transaction: 5687+331.09*3.1416 11.981=9543.882657. The variable PIN for this transaction is (4388), using two digits to the left of the decimal point (43) and two digits to the right (88).

2nd Transaction: 07984+331.09*3.1416/1.981=1790.585131. The variable PIN for this transaction is (9058), using two digits to the left of the decimal point (90) and two digits to the right (58).

Example C (for processing a check and like transactions): Random number which in this case are the last tour digits of the check ID number divided by 245.1279 (selected by the user's choice of their phone number with 4 decimals) adding 250.06 (selected by the user's choice of the last four digits of their credit card with two decimals) and multiplied by 25.01 (selected by the user's choice of their birthday with two decimals)=RESULT (Take two digits to the left and two digits to the right)=variable PIN (four digits).

1st Transaction: 5001/245.1279+250.06*25.01=6764.244477. The variable PIN for this transaction is (6424), using two digits to the left of the decimal point (64) and two digits to the right (24).

2nd Transaction: 7983/245.1279+250.06*25.01=14528.85378. The PIN for this transaction is (2885), using two digits to the left of the decimal point (28) and two digits to the right (85).

It will be appreciated that any of the above examples may be modified to include a variable number, such as a number found on a check, a variable number generated, by a processing entity, or otherwise.

While the invention has been described in connection with preferred embodiments, it is not intended to limit the scope of the invention to the particular forms set forth, but on the contrary, it is intended to cover such alternatives, modifications, and equivalents as may be included within the spirit and scope of the invention, as defined by the appended claims, and claims that may issue.

What is claimed:

1. A method for preventing transactions done without the consent of the account owner comprising the steps of:
creating a variable personal identification number (VPIN) unique to the transaction by account owner;
submitting said VPIN to a clearing institution for verification;
creating a verification or decline authorization by the clearing institution;
allowing or declining said transaction.

2. A method for preventing transactions done without the consent of the account owner wherein said VPIN generated by information pertaining to the transaction and personal information known to the account owner.

3. A method for preventing transactions done without the consent of the account owner as claimed in claim 2 wherein the personal information can include information such as home address, family birthdates, family names, secret numbers, social security number, age and any other type of information that relates to the individual.

4. A method for preventing transactions done without the consent of the account owner as claimed in claim 2 wherein the transactional information can include information such as date, time, check number, date of issuance in your card, amount of the transaction.

5. A method for preventing transactions done without the consent of the account owner as claimed in claim 2 wherein the VPIN is a multi-digit number using the a fixed number of digits taken from the result of a predetermined formula using the information.
